(19) United States
(12) Patent Application Publication
(10) Pub. No.: US 2023/0037345 A1
(43) Pub. Date: Feb. 9, 2023

(54) Cooking apparatus with temperature control

(71) Applicant: NINGBO AGSUN PRODUCTS,INC., Cixi (CN)

(72) Inventors: Xuefei Mao, CIXI (CN); Zecheng Han, CIXI (CN); Bin Shen, CIXI (CN)

(73) Assignee: NINGBO AGSUN PRODUCTS,INC., CIXI (CN)

(21) Appl. No.: 17/965,793

(22) Filed: Oct. 14, 2022

(30) Foreign Application Priority Data
Aug. 12, 2022 (CN) 202222131185.2

(51) Int. Cl. F24C 3/12; A47J 37/07; F24C 7/08

(52) U.S. Cl. CPC F24C 3/124; A47J 37/0713; F24C 7/087

(57) ABSTRACT

The disclosure provides a cooking apparatus with temperature control, where a cooking main body includes a heat supply chamber, the cooking main body is provided with an object placing table, the object placing table includes an accommodation chamber and a mounting hole communicated with the accommodation chamber, a temperature controller is mounted in the mounting hole, the temperature controller includes a main control module, a temperature acquisition module, a power supply module, a liquid crystal display screen, a wireless communication module, a control button, a temperature sensing probe I and a temperature sensing probe II, and where the temperature sensing probe I is mounted on an inner wall of the heat supply chamber, the control button and the liquid crystal display screen are both positioned on one side surface of the temperature controller exposed outside.

### TECHNICAL FIELD

The present disclosure relates to the technical field of a grill device, and in particular to a cooking apparatus with temperature control.

### BACKGROUND

Grilling, perhaps the most original cooking way for human beings, heats food by heating and drying air with fuel and placing the food in a position relatively close to the heat source in the air. Moreover, with the increase in outdoor activities in modern society, gas grilling is more and more popular. However, when the conventional grill is used, the number displayed on the thermometer cannot be seen due to night or low light; at the same time, a condition that the food is often burnt and undercooked appears because the food state can not be accurately grasped in the grilling process. The commercially available grill probe is too expensive to be popularized, so the inventor finally came up with the present disclosure based on the research and improvement aiming at the above defects.

### SUMMARY

In order to solve the above technical defects, the present disclosure is intended to design a cooking apparatus with temperature control, and the specific structure thereof is as follows.

The cooking apparatus with temperature control designed by the present disclosure includes a cooking main body, where the cooking main body includes a heat supply chamber, the cooking main body is provided with an object placing table, the object placing table includes an accommodation chamber and a mounting hole communicated with the accommodation chamber, a temperature controller is mounted in the mounting hole, the temperature controller includes a main control module, a temperature acquisition module, a power supply module, a liquid crystal display screen, a wireless communication module, a control button, a temperature sensing probe I and a temperature sensing probe II, and where the temperature sensing probe I is mounted on an inner wall of the heat supply chamber, the control button and the liquid crystal display screen are both positioned on one side surface of the temperature controller exposed outside, the temperature acquisition module includes a connector I 216 abutting the temperature sensing probe I and a connector II abutting the temperature sensing probe II, and the temperature acquisition module, the power supply module, the control button, the liquid crystal display screen and the wireless communication module are each connected to and controlled by the main control module.

The cooking apparatus with temperature control according to the above, where the temperature controller further includes a temperature sensing probe III, and the temperature acquisition module further includes a connector III abutting the temperature sensing probe III.

The cooking apparatus with temperature control according to the above, where the power supply module includes a power supply module I and a power supply module II, the power supply module I and the power supply module II are each electrically connected to the main control module, a battery is electrically connected to the power supply module I, and a mobile power supply is electrically connected to the power supply module II through a power supply connector.

The cooking apparatus with temperature control according to the above, further including a mobile hand-held terminal, where the wireless communication module includes a Bluetooth module, and the mobile hand-held terminal is interconnected with the Bluetooth module to acquire temperature sensing information.

The cooking apparatus with temperature control according to the above, further including a buzzer, where the buzzer is connected to and controlled by the main control module.

The cooking apparatus with temperature control according to the above, where a protective sleeve is fixed to the inner wall of the heat supply chamber, and the temperature sensing probe I is positioned inside the protective sleeve.

The cooking apparatus with temperature control according to the above, where an outer wall of the object placing table is provided with at least one hook and a through hole communicated with the accommodation chamber.

The cooking apparatus with temperature control according to the above, where the outer wall of the object placing table is provided with a concave part, and at least one hook is formed in the concave part.

The cooking apparatus with temperature control according to the above, where the cooking main body is further provided with a side grill module, the side grill module includes an outer grill body, an inner grill body and a cover body, the outer grill body includes a heating port, the heating port is provided with a skirt edge extending downwards, an inner side of the skirt edge is provided with a first limiting body, the inner grill body is arranged within the heating port, the inner grill body is provided with a second limiting body, and the first limiting body and the second limiting body limit each other to position and mount the inner grill body; the inner grill body includes a heating chamber, a heating grill head and a frame configured to place food or a pot body are mounted within the heating chamber, and the heating grill head is positioned below an object placing part of the frame; the first limiting body includes first limiting sheets arranged on at least two sides of the skirt edge, the second limiting body includes second limiting sheets arranged on at least two sides of the inner grill body, and the second limiting sheets are stacked and limited on the first limiting sheets; the cover body covers the heating port, at least one part of the cover body is hinged with a pin shaft at one side part of the heating port, and a plurality of ventilation holes communicated with the outside are provided on the heating chamber.

The cooking apparatus with temperature control according to the above, further including a hinge rod, where the hinge rod is positioned between side edge parts of two opposite sides of the cover body, at least one part of the cover body is positioned between the two opposite sides of the skirt edge, and two ends of the hinge rod penetrate through the side edge parts of the two opposite sides of the cover body, respectively, and then are inserted into insertion holes on the two opposite sides of the skirt edge; one end of the hinge rod is sleeved with a spring, two ends of the hinge rod are each provided with limiting parts, two ends of the spring abut against one limiting part and one side edge part of the cover body, respectively, and the other limiting part abuts against the other side edge part of the cover body or one side on the skirt edge.

The cooking apparatus with temperature control according to the above, where the frame includes a first leg, a second leg, a third leg, a fourth leg, a fifth leg and a sixth leg, a bottom surface of the heating chamber is provided with a first positioning groove, a second positioning groove and a third positioning groove in an annular array, the first leg, the third leg and the fifth leg are inserted into the first positioning groove, the second positioning groove and the third positioning groove, respectively, and bottom ends of the second leg, the fourth leg and the sixth leg abut against the bottom surface of the heating chamber.

The cooking apparatus with temperature control designed by the present disclosure has the following beneficial effects:

1. The temperature sensing probe transmits a sensed temperature to the main control module through the temperature acquisition module, the main control module converts an analogue signal into digital information, and the sensed temperature is displayed on the liquid crystal display screen, so as to know the current temperature inside the heat supply chamber or of food at night or in an environment with poor light.

2. The table top of the object placing table can be configured to place sundries.

3. The temperature inside the heat supply chamber and the temperature of the food can be separately known with three temperature sensing probes, so as to avoid the phenomenon that the food is burnt and undercooked.

4. Communication and interconnection with APP software in the mobile hand-held terminal can be performed with the Bluetooth module, so as to realize the remote monitoring of the temperature inside the heat supply chamber and the temperature of the food.

5. The arrangement of the side grill module can preheat the food and then the preheated food is put into the heat supply chamber for cooking, so as to improve the efficiency of food cooking.

### BRIEF DESCRIPTION OF THE DRAWINGS

FIG. 1 is a schematic diagram (I) of the overall structure of a cooking apparatus;

FIG. 2 is a schematic diagram (II) of the overall structure of a cooking apparatus;

FIG. 3 is a schematic diagram (III) of the overall structure of a cooking apparatus;

FIG. 4 is a schematic diagram of the system structure of a temperature controller;

FIG. 5 is a schematic diagram of the structure of a main control module;

FIG. 6 is a schematic diagram of the structure of a power supply module;

FIG. 7 is a schematic diagram of the structure of a temperature acquisition module;

FIG. 8 is a schematic diagram of the structure of a buzzer;

FIG. 9 is a schematic diagram of the circuit structure of a liquid crystal display screen;

FIG. 10 shows the circuit structure of a Bluetooth module;

FIG. 11 is a schematic diagram (I) of the structure of the side grill module;

FIG. 12 is a schematic diagram (II) of the structure of the side grill module;

FIG. 13 is an exploded view (I);

FIG. 14 is an exploded view (II);

FIG. 15 is a schematic diagram of the structure of a grill body; and

FIG. 16 is a schematic diagram of the explosion structure of a grill body.

### DETAILED DESCRIPTION OF THE EMBODIMENTS

The technical schemes in the embodiments of the present disclosure will be clearly and completely described below with reference to the drawings in the embodiments of the present disclosure. It is apparent that the described embodiments are only some, but not all, embodiments of the present disclosure. Based on the embodiments in the present disclosure, all other embodiments obtained by those of ordinary skill in the art fall within the protection scope of the present disclosure.

### Embodiment

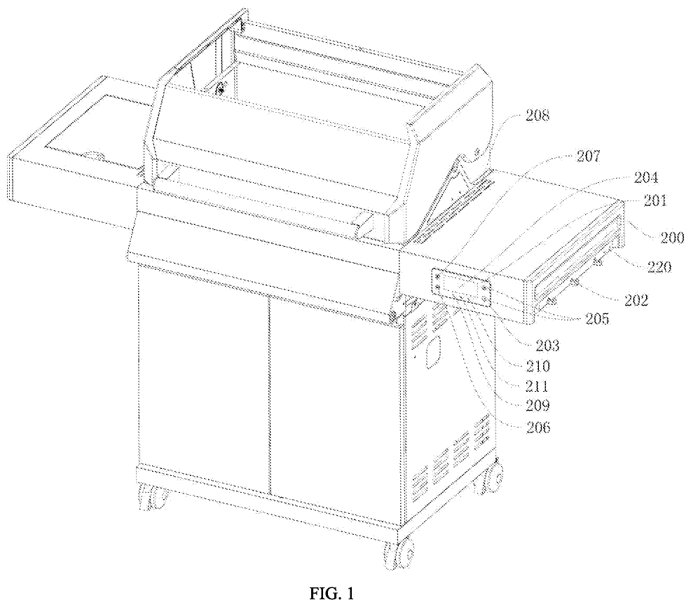

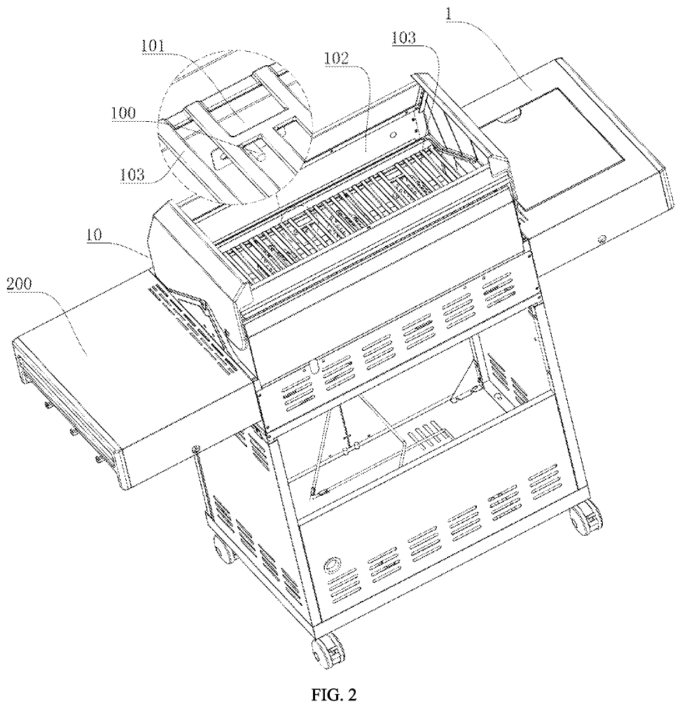

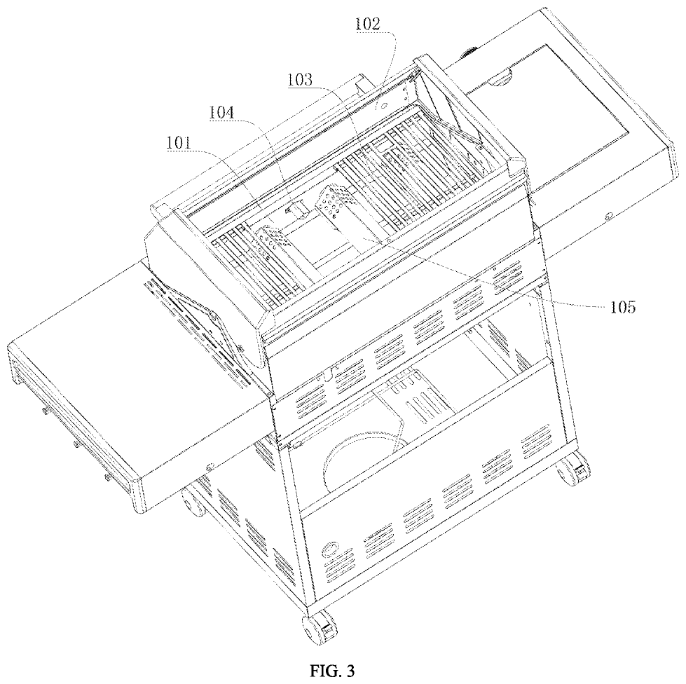

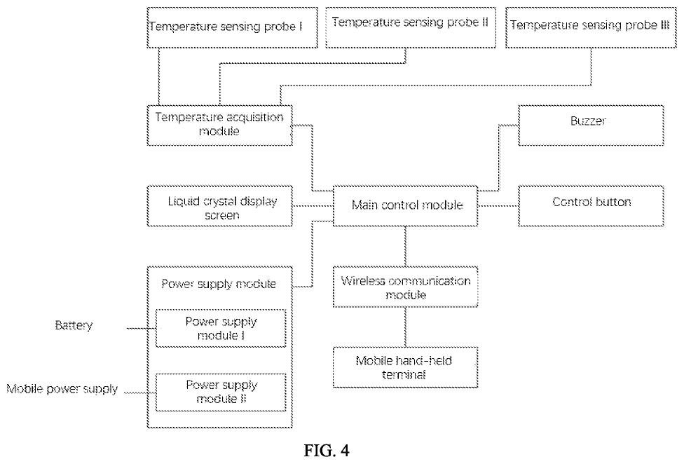

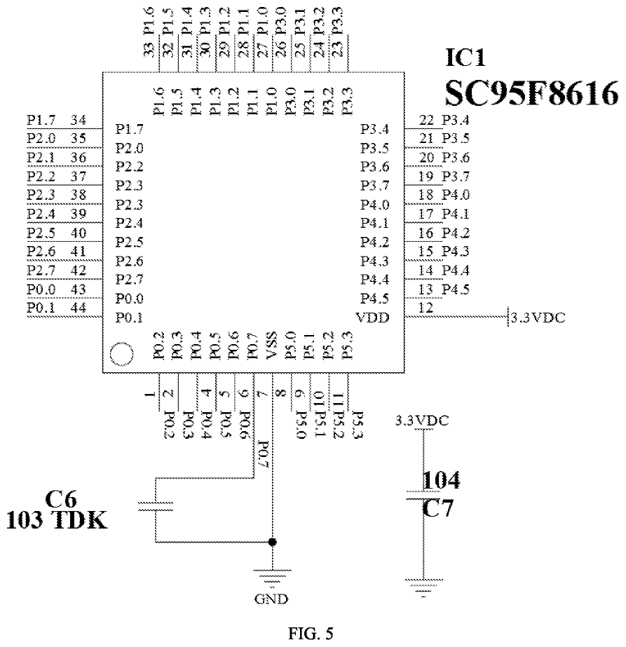

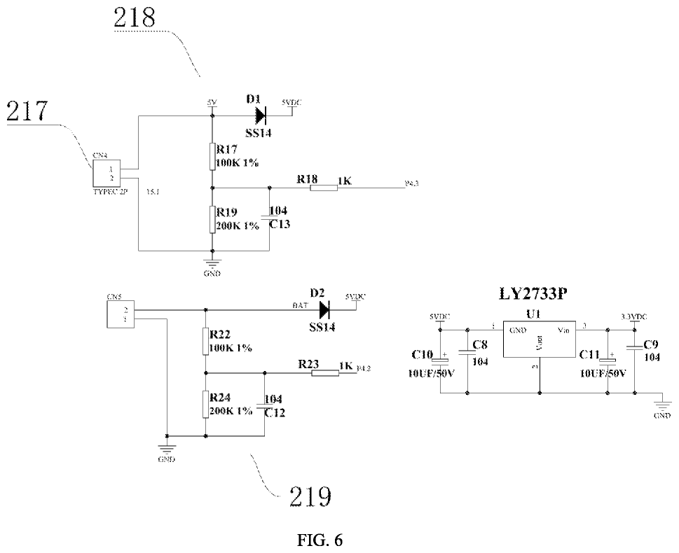

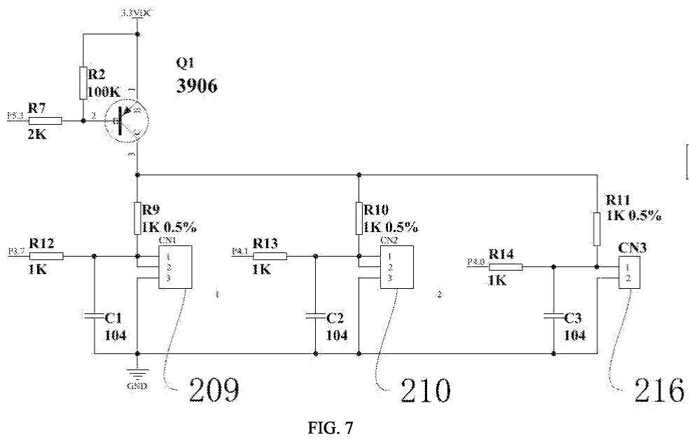

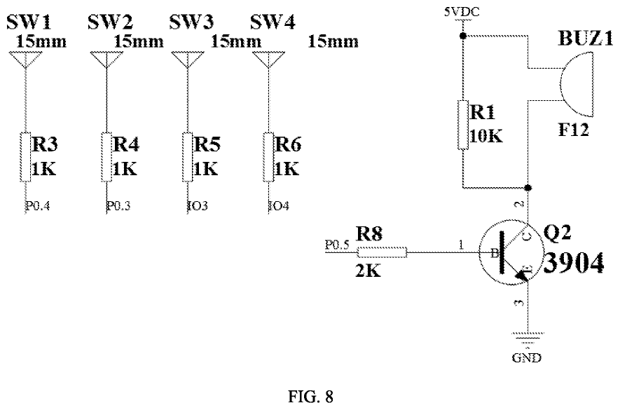

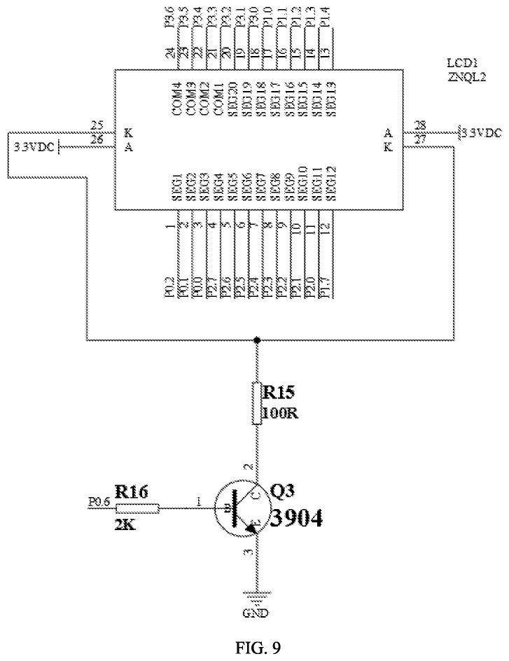

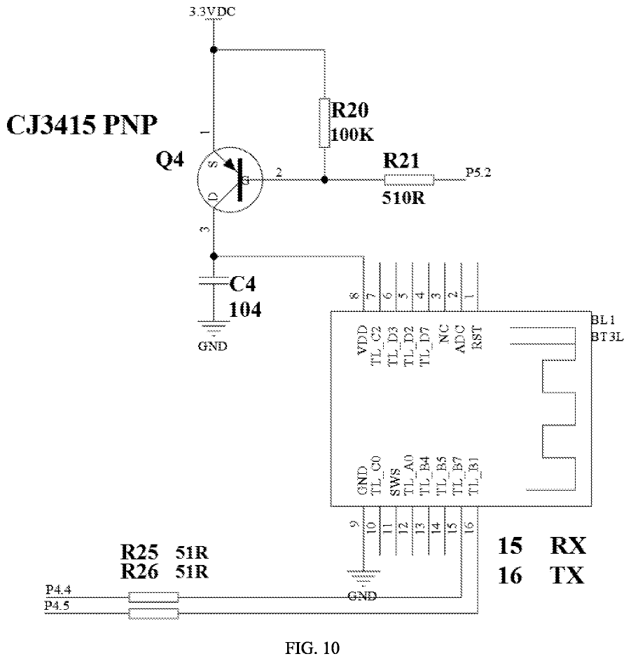

As shown in FIG. 1 to FIG. 10, the cooking apparatus with temperature control described in the present embodiment includes a cooking main body 10, where the cooking main body 10 includes a heat supply chamber 101 and a cooking chamber 102 positioned above the heat supply chamber 101, the heat supply chamber 101 and the cooking chamber 102 are separated by a metal grid frame 103, a gas grill head and a fire distributing plate 105 positioned above the gas grill head are mounted in the heat supply chamber 101, and when the gas grill head is ignited, fire is distributed by the fire distributing plate 105 so as to grill food on the metal grid frame 103.

The cooking main body 10 is an grill, and an object placing table 200 is fixed to the cooking main body 10 with a bolt, the object placing table 200 is formed by bending a stainless steel sheet metal piece, and the object placing table 200 includes an accommodation chamber and an mounting hole communicated with the accommodation chamber; a temperature controller 203 is mounted in the mounting hole, and the temperature controller 203 includes a housing 201, a temperature sensing probe I 100, a temperature sensing probe II, a temperature sensing probe III and a control button, as well as a main control module, a temperature acquisition module, a power supply module, a liquid crystal display screen 204, a wireless communication module and a buzzer that are arranged within the housing 201; the temperature sensing probe I 100 passes through and is fixed on an inner wall of the heat supply chamber 101, the control button and the liquid crystal display screen 201 are both positioned on one side surface of the housing 201 exposed outside, and the side surface is a control surface; the control button includes a temperature threshold setting button 205, a power supply button 207 and a setting button 206, and the temperature acquisition module includes a connector I 216 abutting the temperature sensing probe I, a connector II 209 abutting the temperature sensing probe II and a connector III 210 abutting the temperature sensing probe III; and the buzzer, the temperature acquisition module, the power supply module, the control button, the liquid crystal display screen 204 and the wireless communication module are each connected to and controlled by the main control module, where the main control module is an IC chip with the built-in temperature information conversion program and setting program for setting a maximum temperature threshold and a minimum temperature threshold, so that the functions of displaying a temperature and giving an alarm when the temperature is lower than the minimum threshold or higher than the maximum threshold are realized, where the buzzer can be adopted for alarming.

The temperature sensing probe I 100 is configured to sense the temperature inside the heat supply chamber 101, a long electrical connection line is provided between the temperature sensing probe II and the connector II 209, and a long electrical connection line is also provided between the temperature sensing probe II and the connector II 209, so that the temperature sensing probe I can be contacted with food being grilled, the temperature of the food being grilled is sensed, the sensed temperature is input to the main control module, the main control module is converted through a software program, and the temperature is displayed on the liquid crystal display screen 204; thus, the food state can be accurately grasped in the grilling process, avoiding the appearance of a condition that the food is burnt and undercooked.

The power supply module includes a power supply module I 218 and a power supply module II 219, where the power supply module I 218 and the power supply module II 219 are each electrically connected to the main control module, a battery is electrically connected to the power supply module I 218, and a mobile power supply is electrically connected to the power supply module II 219 through a power supply connector 217, where the power supply connector 217 is a Type-c interface; and the temperature controller 203 can be powered by the battery, or when the battery is low, the mobile power supply is connected to the Type-c interface through a data line to supply power to the temperature controller 203.

A mobile hand-held terminal is further included, the wireless communication module includes a Bluetooth module, the mobile hand-held terminal is interconnected with the Bluetooth module to acquire temperature sensing information, and the mobile hand-held terminal is provided with APP software to acquire temperature information.

A protective sleeve 104 is fixed to the inner wall of the heat supply chamber 101 with a bolt, and the temperature sensing probe I 100 is positioned in the protective sleeve 104 to protect inside the temperature sensing probe I 100.

The outer wall of the object placing table 200 is provided with at least one hook 202 and a through hole 208 communicated with the accommodation chamber, the outer wall of the object placing table 200 is provided with a concave part 220, at least one hook 202 is formed in the concave part 220, there may be a plurality of hooks 202, and the through hole 208 is configured for heat dissipation and ventilation, and the hooks 202 are configured for hanging objects.

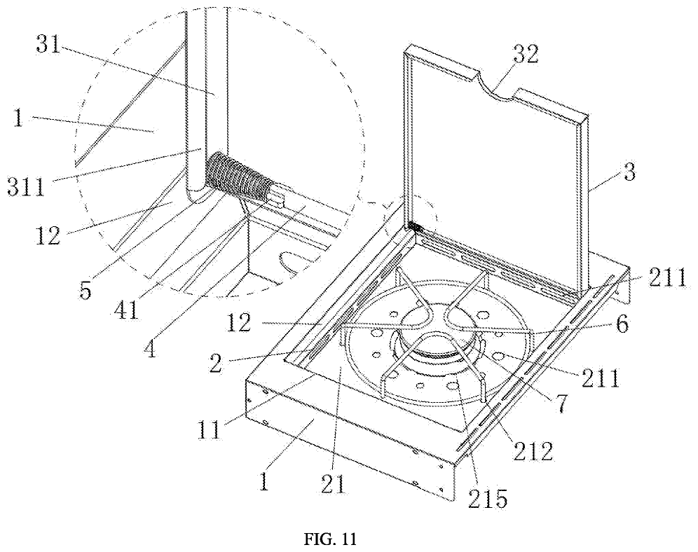

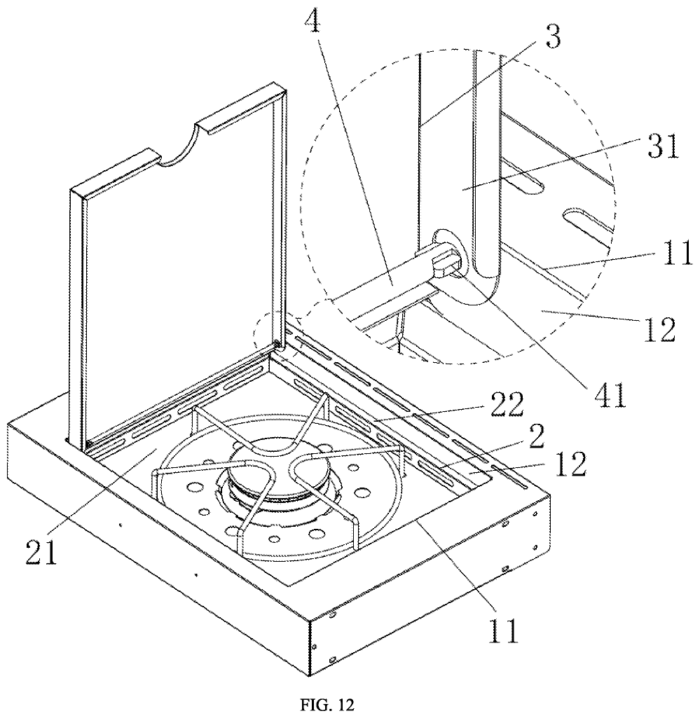

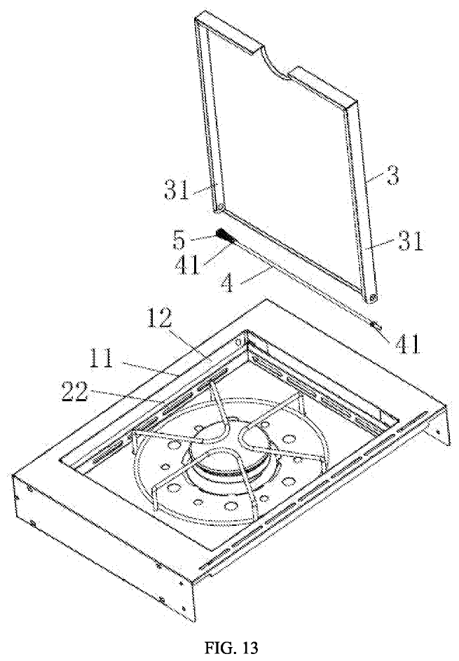

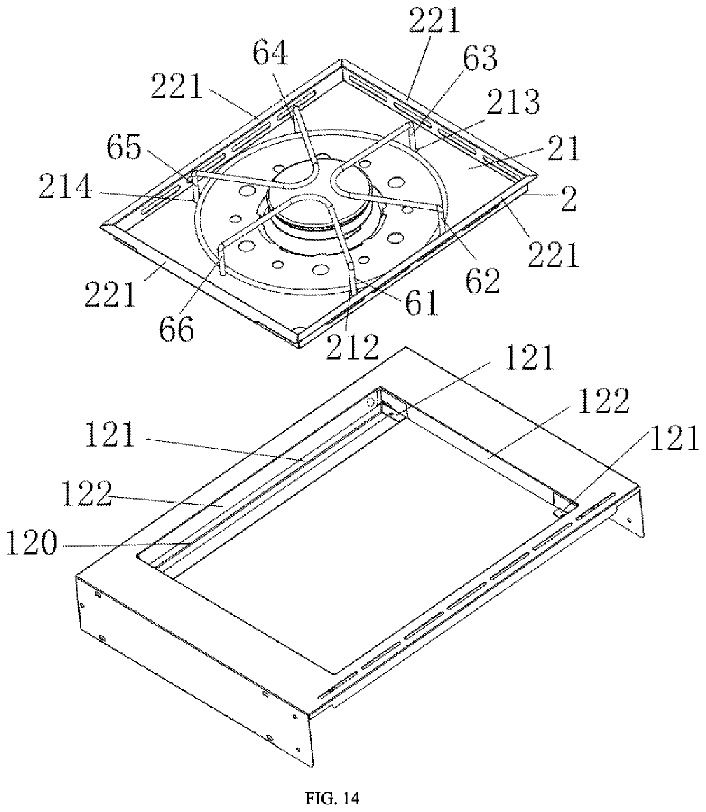

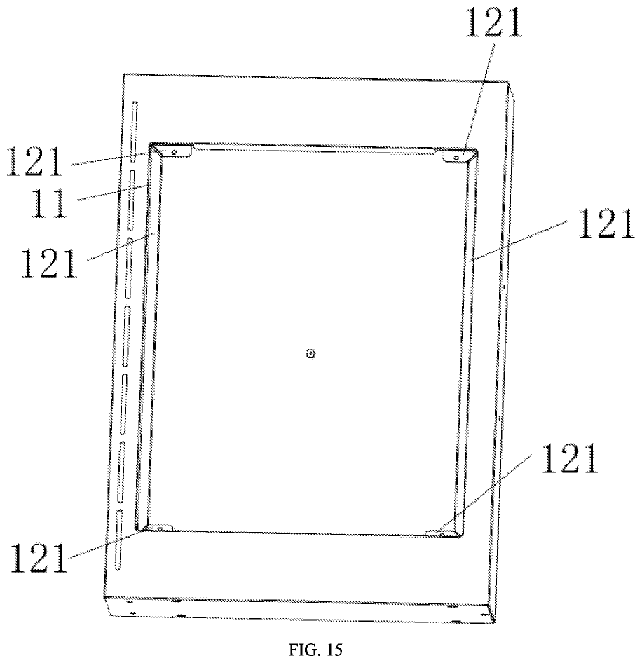

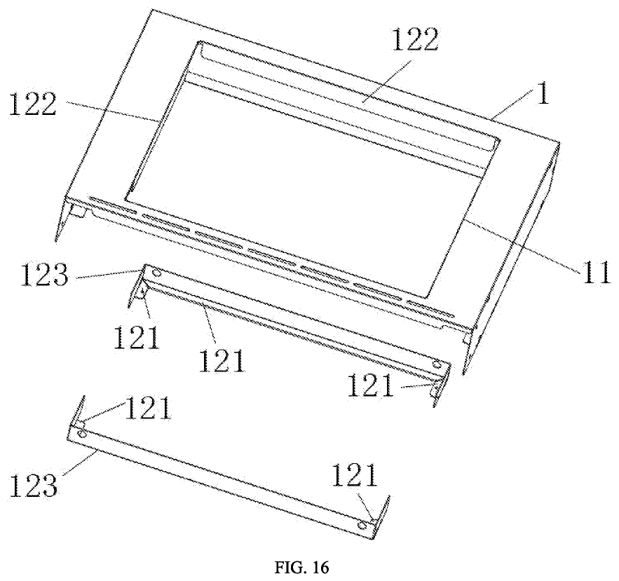

In the present embodiment, as shown in FIG. 11 to FIG. 17, the cooking main body 10 is further provided with a side grill module, the side grill module includes an outer grill body 1, an inner grill body 2 and a cover body 3, the outer grill body 1 includes a heating port 11, the heating port 11 is provided with a skirt edge 12 extending downwards, an inner side of the skirt edge 12 is provided with a first limiting body 120, the inner grill body 2 is arranged within the heating port 11, the inner grill body 2 is provided with a second limiting body 22, and the first limiting body 120 and the second limiting body 22 limit each other to position and mount the inner grill body 2; and the cover body 3 is covered on the heating port 11, at least one part of the cover body 3 is hinged with a pin shaft at one side part of the heating port 11, and the arrangement of the cover body 3 can enable that the cover body 3 is closed when not in use and the cover body 3 is opened when in use. Dust and the like are prevented from entering the grill head after the cover body is closed, where the cover body 3 is made of metal, and the outer grill body 1 can be fixed to the cooking main body 10 by welding or bolting.

The inner grill body 2 includes a heating chamber 21, a heating grill head 7 and a frame 6 configured to place food or a pot body are mounted within the heating chamber 21, the heating grill head 7 is positioned below an object placing part of the frame 6, the outer grill body 1 and the inner grill body 2 are both made of metal, and the heating grill head 7 adopts any grill head in the known art which is matched with a through-hole 215 on the heating chamber 21, so the heating grill head will not be described in detail herein. Therefore, the food is grilled after being heated by the grill head, and the frame 6 is a hollow frame 6; in addition, the arrangement of the skirt edge 12 enables the heating chamber 21 to sink deeper after the inner grill body 2 is mounted on the skirt edge 12, so that the grill head sinks into the heating port 11, the temperature escape of the grill head after heating is avoided, and the heat collecting function is realized, where the skirt edge 12 can be four side edges of the heating port 11 each extending downwards with sheet bodies 122, and sheet bodies 122 are connected with each other by connecting bodies; or the skirt edge 12 can also be an annular skirt edge.

Preferably, the first limiting body 120 includes first limiting sheets 121 arranged on at least two sides of the skirt edge 12, the second limiting body 22 includes second limiting sheets 221 arranged on at least two sides of the inner grill body 2, the second limiting sheets 221 are stacked and limited on the first limiting sheets 121, and the structural arrangement thereof enables it convenient to mount and dismount the inner grill body 2.

Based on the above description, the connecting body is provided with two U-shaped frames 123, the transverse parts of the two U-shaped frames 123 are fixed with two oppositely arranged sheet bodies 122 by welding or bolting, respectively, the end parts of two longitudinal parts of one U-shaped frame 123 abut one end part of the other two oppositely arranged sheet bodies 122, the end parts of two longitudinal parts of the other U-shaped frame 123 abut the other end parts of the other two oppositely arranged sheet bodies 122, and lower side edges of the longitudinal parts and the transverse parts of the two U-shaped frames 123 extend with first limiting sheets 121.

Preferably, a hinge rod 4 is further included, the hinge rod 4 is positioned between side edge parts of two opposite sides of the cover body 3, at least one part of the cover body 3 is positioned between the two opposite sides of the skirt edge 12, two ends of the hinge rod 4 penetrate through the side edge parts 31 of the two opposite sides of the cover body 3, respectively, and then are inserted into insertion holes on the two opposite sides of the skirt edge 12, the structural arrangement thereof enables the hinged-mounting and dismounting of the pin shaft of the cover body 3 to be more convenient, the hinge rod 4 is a metal rod, and the side edge parts 31 of the two opposite sides of the cover body 3 are provided with convex sheets 311 to limit end parts of the hinge rod 4.

More preferably, one end of the hinge rod 4 is sleeved with a spring 5, two ends of the hinge rod 4 are each provided with limiting parts 41, two ends of the spring 5 abut against one limiting part 41 and one side edge part 31 of the cover body 3, respectively, and the other limiting part 41 abut against the other side edge part 31 of the cover body 3 or one side on the skirt edge 12; or two ends of the hinge rod 4 are each sleeved with springs 5, two ends of the hinge rod 4 are each provided with limiting parts 41, two ends of one spring 5 abut against one limiting part 41 and one side edge part of the cover body 3, respectively, two ends of the other spring 5 abut against the other limiting part 41 and the other side edge part of the cover body 3, respectively, and the elastic forces of the two springs 5 are equal. The structural arrangement thereof enables the hinged-mounting of the pin shaft to be stable and reliable and improves the service performance, where the limiting part 41 is a convex block, and the spring 5 preferentially adopts a conical spring 5.

Preferably, the cover body 3 is provided with a pulling part 32 for easily turning up the cover body 3, and the pulling part 32 includes a notch or a handle.

Preferably, the heating chamber 21 is provided with a plurality of ventilation holes 211 communicated with the outside, and the ventilation holes 211 may be arranged on both side walls and the bottom surface of the heating chamber 21 to increase the oxygen content of flame combustion.

In some preferred embodiments, the frame 6 includes a first leg 61, a second leg 62, a third leg 63, a fourth leg 64, a fifth leg 65 and a sixth leg 66, a bottom surface of the heating chamber 21 is provided with a first positioning groove 212, a second positioning groove 213 and a third positioning groove 214 in an annular array, the first leg 61, the third leg 63 and the fifth leg 65 are inserted into the first positioning groove 212, the second positioning groove 213 and the third positioning groove 214, respectively, bottom ends of the second leg 62, the fourth leg 64 and the sixth leg 66 abut against the bottom surface of the heating chamber 21, the structure thereof realizes convenient mounting and dismounting of the frame 6, and when three positioning grooves are adopted, the positioning grooves may adopt a through-type structure or a non-through-type structure.

The arrangement of the side grill module can preheat food, and the inner grill body 2 and the outer grill body 1 are positioned in a limiting manner through the limiting body, so that the inner grill body 2 can be dismounted without dismounting a screw, and the inner grill body 2 can be conveniently taken out for replacement or cleaning; in addition, when the pin shaft is hinged with the cover body 3, the cover body 3 can be dismounted, so that the inner grill body 2 can be taken out after the cover body 3 is dismounted, thereby avoiding the condition where the inner grill body 2 cannot be dismounted when dismounting the side grill module by a consumer.

The present disclosure is not limited to the above optimal embodiments, and any other various products may be obtained by anyone in light of the present disclosure. However, no matter what change in shape or structure thereof is made, all technical schemes that are identical or similar to those of the present disclosure will fall within the protection scope of the present disclosure.

What is claimed is:

1. A cooking apparatus with temperature control, comprising a cooking main body, the cooking main body comprising a heat supply chamber, wherein the cooking main body is provided with an object placing table, the object placing table comprises an accommodation chamber and a mounting hole communicated with the accommodation chamber, a temperature controller is mounted in the mounting hole, the temperature controller comprises a main control module, a temperature acquisition module, a power supply module, a liquid crystal display screen, a wireless communication module, a control button, a temperature sensing probe I and a temperature sensing probe II, and wherein the temperature sensing probe I is mounted on an inner wall of the heat supply chamber, the control button and the liquid crystal display screen are both positioned on one side surface of the temperature controller exposed outside, the temperature acquisition module comprises a connector I abutting the temperature sensing probe I and a connector II abutting the temperature sensing probe II, and the temperature acquisition module, the power supply module, the control button, the liquid crystal display screen and the wireless communication module are each connected to and controlled by the main control module.

2. The cooking apparatus with temperature control according to claim 1, wherein the temperature controller further comprises a temperature sensing probe III, and the temperature acquisition module further comprises a connector III abutting the temperature sensing probe III.

3. The cooking apparatus with temperature control according to claim 2, wherein the power supply module comprises a power supply module I and a power supply module II, the power supply module I and the power supply module II are each electrically connected to the main control module, a battery is electrically connected to the power supply module I, and a mobile power supply is electrically connected to the power supply module II through a power supply connector.

4. The cooking apparatus with temperature control according to claim 3, further comprising a mobile hand-held terminal, wherein the wireless communication module comprises a Bluetooth module, and the mobile hand-held terminal is interconnected with the Bluetooth module to acquire temperature sensing information.

5. The cooking apparatus with temperature control according to claim 4, further comprising a buzzer, wherein the buzzer is connected to and controlled by the main control module.

6. The cooking apparatus with temperature control according to claim 1, wherein a protective sleeve is fixed to the inner wall of the heat supply chamber, and the temperature sensing probe I is positioned inside the protective sleeve.

7. The cooking apparatus with temperature control according to claim 6, wherein an outer wall of the object placing table is provided with a concave part, and at least one hook is formed in the concave part.

8. The cooking apparatus with temperature control according to claim 1, wherein the cooking main body is further provided with a side grill module, the side grill module comprises an outer grill body, an inner grill body and a cover body, the outer grill body comprises a heating port, the heating port is provided with a skirt edge extending downwards, an inner side of the skirt edge is provided with a first limiting body, the inner grill body is arranged within the heating port, the inner grill body is provided with a second limiting body, and the first limiting body and the second limiting body limit each other to position and mount the inner grill body; the inner grill body comprises a heating chamber, a heating grill head and a frame configured to place food or a pot body are mounted within the heating chamber, and the heating grill head is positioned below an object placing part of the frame; the first limiting body comprises first limiting sheets arranged on at least two sides of the skirt edge, the second limiting body comprises second limiting sheets arranged on at least two sides of the inner grill body, and the second limiting sheets are stacked and limited on the first limiting sheets; the cover body covers the heating port, at least one part of the cover body is hinged with a pin shaft at one side part of the heating port, and a plurality of ventilation holes communicated with the outside are provided on the heating chamber.

9. The cooking apparatus with temperature control according to claim 8, further comprising a hinge rod, wherein the hinge rod is positioned between side edge parts of two opposite sides of the cover body, at least one part of the cover body is positioned between the two opposite sides of the skirt edge, and two ends of the hinge rod penetrate through the side edge parts of the two opposite sides of the cover body, respectively, and then are inserted into insertion holes on the two opposite sides of the skirt edge; one end of the hinge rod is sleeved with a spring, two ends of the hinge rod are each provided with limiting parts, two ends of the spring abut against one limiting part and one side edge part of the cover body, respectively, and the other limiting part abuts against the other side edge part of the cover body or one side on the skirt edge.

10. The cooking apparatus with temperature control according to claim 9, wherein the frame comprises a first leg, a second leg, a third leg, a fourth leg, a fifth leg and a sixth leg, a bottom surface of the heating chamber is provided with a first positioning groove, a second positioning groove and a third positioning groove in an annular array, the first leg, the third leg and the fifth leg are inserted into the first positioning groove, the second positioning groove and the third positioning groove, respectively, and bottom ends of the second leg, the fourth leg and the sixth leg abut against the bottom surface of the heating chamber.
